(19) United States
(12) Patent Application Publication
(10) Pub. No.: US 2026/0201989 A1
(43) Pub. Date: Jul. 16, 2026

(54) CONTROL VALVE FOR HEAT TREATMENT CIRCUIT

(71) Applicant: Valeo Systemes Thermiques, Le Mesnil-Saint-Denis (FR)

(72) Inventors: Christophe Thullier, Le Mesnil-Saint-Denis (FR); Said Baahmed, Le Mesnil-Saint-Denis (FR)

(73) Assignee: Valeo Systemes Thermiques, Le Mesnil-Saint-Denis (FR)

(21) Appl. No.: 19/134,506

(22) PCT Filed: Nov. 27, 2023
(86) PCT No.: PCT/EP2023/083141

§ 371 Date: May 30, 2025

(30) Foreign Application Priority Data
Dec. 1, 2022 (FR) 2212615

(51) Int. Cl. F16L 29/00

(52) U.S. Cl. CPC F16L 29/007

(57) ABSTRACT

A control valve (1) for a fluid circulation for a heat treatment circuit of a vehicle is disclosed. The control valve includes a first connection element (2) and a second connection element (3) mechanically interacting with the first connection element (2), the first connection element (2) and the second connection element (3) both defining an internal volume (9), characterized in that the control valve (1) further comprises a pipe (8) formed by the internal volume (9) of the first connection element (2) and by the internal volume (9) of the second connection element (3), as well as a control device (10) at least partially integrated within the pipe (8).

The present invention relates to the field of heat treatment circuits and more particularly relates to a fluid control valve which circulates within such heat treatment circuits.

Heat treatment circuits, for example, within a motor vehicle, ensure the circulation of a fluid so that it thermally treats a component by heat exchange. The elements which are capable of discharging heat can thus be cooled by the fluid. Such a fluid may be a refrigerating fluid of the R134a or R1234yf type or a heat exchange fluid, such as glycol water.

Heat treatment circuits generally comprise a plurality of branches and it is important to control the circulation of the fluid within these branches, for example, by means of control valves capable of allowing or preventing the circulation of the fluid. The control of the circulation of fluid can be carried out in particular by means of a control device which allows the fluid circulation in a single circulation direction, preventing any fluid circulation in the opposite circulation direction. The control device thus prevents a return of circulation fluid which can be detrimental to the thermal equilibrium of the heat treatment circuit.

This type of control valve generally comprises a housing which has at either side two connection elements which are attached to the housing and which allow the mechanical and fluidic connection of the control valve to the circuit, the housing having dimensions so as to receive therein the control device, the displacements of which control the circulation of the fluid within the housing. These control valves are functional and effective but the housing has a substantial mechanical spatial requirement which can add to the installation constraints in terms of these heat treatment circuits, the basic structure of which is already complex to implement.

The present invention allows a reduction in the mechanical spatial requirement of the control valves by providing a control valve for a fluid circulation for a heat treatment circuit of a vehicle, comprising a first connection element and a second connection element which mechanically interacts with the first connection element, the first connection element and the second connection element both defining an internal volume, characterized in that the control valve further comprises a conduit which is formed by the internal volume of the first connection element and by the internal volume of the second connection element and a control device which is at least partially integrated within the conduit.

The volume of the control valve is thus greatly reduced because it is the connection elements themselves which contain the control device, which ensures that the housing interposed in the prior art between the connection elements is dispensed with.

The first connection element and the second connection element allow two portions of the heat treatment circuit to be connected both mechanically and fluidically. The fluid can thus circulate from one connection element to another passing through the respective internal volume thereof, on condition that the control device allows this circulation.

The conduit is formed when the connection elements interact mechanically with each other. Each of the internal volumes constitutes a portion of the conduit. When the connection elements are mechanically connected, the internal volumes of each of them are each opposite the other and thus form the conduit in its entirety.

The at least partial integration of the control device in the connection elements thus greatly limits the mechanical spatial requirement of the control valve.

According to a feature of the invention, the control device is integrally arranged within the conduit. In other words, the control device can be completely integrated in the internal volume of the first connection element or completely integrated in the internal volume of the second connection element or completely integrated in an overall internal volume which combines the internal volumes of each of the connection elements.

According to a feature of the invention, the control device comprises a piston/spring assembly which is configured to block one direction of circulation of the fluid which circulates in the conduit. In other words, the control device forms a non-return device which allows only one circulation direction of the fluid through the control valve.

The piston/spring assembly comprises a piston and a spring. The piston is capable of moving in a direction parallel with a main circulation direction of the fluid in the conduit between a first position and a second position.

When the piston is positioned in accordance with the first position, the control device is closed, preventing any fluid circulation through it. When the piston is positioned in accordance with the second position, the control device is open and allows a fluid flow.

The spring is mounted around the piston and has a return force which keeps the piston positioned in accordance with the first position. In other words, without any external pressure on the control device, the spring is completely relaxed, thereby closing the control device.

When the piston is displaced from the first position to the second position, it lifts a valve of the control device. By being lifted, the valve releases a passage within which the fluid can circulate and thus pass through the control device.

The displacement of the piston can be carried out by means of the pressure which is applied by the circulation of the fluid to the piston on condition that the direction of the circulation is the one which is allowed by the control device. The pressure of the fluid on the piston is such that the fluid pushes the piston and compresses the spring. Therefore, the valve is lifted and the control device is opened, allowing the flow of the fluid. If the pressure applied by the fluid to the piston is stopped, the spring relaxes and repositions the piston in accordance with the first position, thereby closing the control device.

According to a feature of the invention, the first connection element and the second connection element comprise fixing means, the fixing means ensuring positioning of the internal volumes of the first connection element and the second connection element opposite each other. Each connection element comprises a plate which forms the body of this connection element and which defines therein the internal volume belonging to the connection element. The plate has a protruding radial portion, on which the fixing means associated with the connection element are arranged.

The plate of each connection element extends so as to be opposite the other plate when the connection elements are positioned one against the other in order to form the control valve.

The fixing means are configured to allow fixing of one connection element to the other and to allow a mechanical connection which concludes the formation of the conduit between the two connection elements. The fixing means may be formed, for example, by a screw/nut assembly. The screw projects from the plate of the first connection element so as to pass through an opening which is formed within the plate of the second connection element. The nut is then screwed to the thread of the screw in order to press the plates one against the other.

According to a feature of the invention, the first connection element and the second connection element comprise an internal wall which at least partially defines the internal volume, the control device comprising an external wall which is arranged opposite at least one of the internal walls of the first connection element or the second connection element. The control device and the internal volume of each connection element are preferably of cylindrical form with a circular cross section. Thus, the control device can be arranged within the internal volume of one and or the other of the internal volumes in an easier manner.

The cylindrical shape of the control device has a diameter which is substantially less than a diameter of the internal volume(s) in order to be able to be mounted therein. Once the assembly has been carried out, the external wall of the control device is opposite or substantially in direct contact with the internal wall of the conduit, that is to say of the internal volume(s) of at least one of the connection elements.

According to a feature of the invention, the control device comprises at least one sealing member which extends along the external wall, the sealing member being in direct contact with the internal wall of at least the first connection element or the second connection element. The sealing member may, for example, be an annular joint which extends around a section of the external wall of the control device. The external wall may, for example, comprise a groove which forms a receptacle for the sealing member.

Therefore, the sealing member is intercalated between the external wall of the control device and the internal wall of one of the connection elements. The sealing member prevents the fluid from circulating and becoming introduced between the control device and the internal wall of one of the connection elements. Thus, the fluid can circulate within the control valve only by passing through the control device.

If the control device is arranged within the internal volume of only one of the connection elements and if the control device comprises a plurality of sealing members, the group of these sealing members is intercalated between the control device and the internal wall of only the connection element within which the control device is received. The fact of arranging several sealing members is advantageous in the sense that the sealing is reinforced and safeguarded if there are several sealing members.

If the control device is arranged partially within the internal volume of the first connection element and partially within the internal volume of the second connection element, the control device comprises at least two sealing members, at least one of which is intercalated between the control device and the internal wall of the first connection element and at least a second of which is intercalated between the control device and the internal wall of the second connection element. Thus, the sealing is ensured with each of the connection elements. In an advantageous manner, two sealing members are intercalated between the control device and each of the internal walls of each of the connection elements in order to reinforce the sealing.

According to a feature of the invention, the control device comprises two fluidic connectors, each of the fluidic connectors being capable of being inserted within each of the internal volumes of each of the connection elements by form-fitting connection. This is a first embodiment of the control valve according to the invention. Each fluidic connector is arranged at an axial end of the control device and is associated with one of the connection elements having a diameter which allows insertion within the internal volume of its respective connection element. It will be understood that the external wall of the control device on which the sealing member is positioned corresponds to at least one of the fluidic connections.

In this first embodiment, the control device is partially integrated within each internal volume of the connection elements. Therefore, the control device advantageously comprises at least one sealing member around each of the fluidic connectors of the control device.

According to a feature of the invention, the first connection element comprises an end piece which is capable of being inserted within the internal volume of the second connection element by form-fitting connection. In other words, the end piece of the first connection element has a diameter which is substantially less than the diameter of the internal wall of the second connection element. This allows partial insertion of the first connection element within the second connection element. According to a feature of the invention, the end piece comprises an external surface which is arranged opposite the internal wall of the second connection element, the end piece comprising at least one sealing element which extends along the external surface, the sealing element being in direct contact with the internal wall of the second connection element. This is a second embodiment of the control valve according to the invention.

Once the end piece is inserted in the internal volume of the second connection element, the external surface of the end piece is opposite, or substantially in direct contact with the internal wall of the second connection element. The sealing element ensures the sealing between the external surface of the end piece and the internal wall of the second connection element. The fluid thus cannot circulate by being introduced between the first connection element and the second connection element. Advantageously, the control device is further also provided with the sealing member in order to reinforce the sealing.

According to a feature of the invention, the control device is engaged between the second connection element and the end piece. Advantageously, the diameter of the end piece and the diameter of the control device are identical or substantially identical. The end piece, at the time of insertion, also pushes the control device within the internal volume of the second connection element. Thus, the sealing is produced between the control device and the internal wall of the second connection element via the sealing member and at the same time between the end piece and the internal wall of the second connection element via the sealing element.

According to a feature of the invention, the first connection element and/or the second connection element comprise(s) at least a conduit portion which is configured to mechanically and fluidically connect the control valve to the heat treatment circuit. The conduit portion of one of the connection elements corresponds to the opposite end to the one opposite the other connection element. The conduit portion has connection means with respect to any type of element, for example, a pipe, a heat exchanger, an expansion member or any other element of the heat treatment circuit within which the control valve is arranged.

Other features and advantages of the invention will become more clearly apparent on the one hand from the following description, and on the other hand from a plurality of examples of embodiment that are given non-limitingly and by way of indication with reference to the appended schematic drawings, in which:

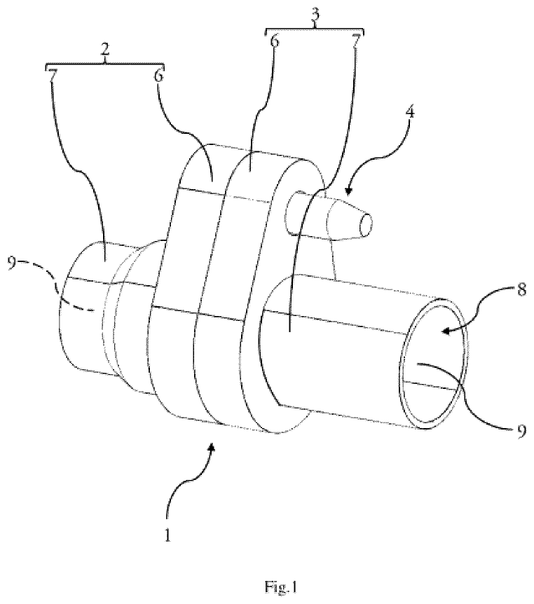

FIG. 1 shows a general view of a first embodiment of a control valve according to the invention,

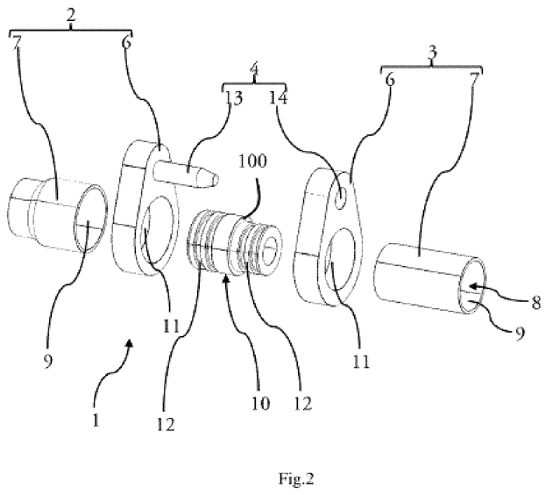

FIG. 2 shows an exploded view of the first embodiment of the control valve,

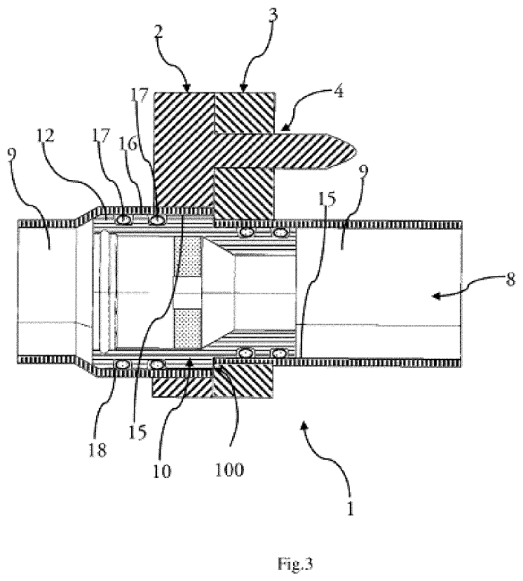

FIG. 3 shows a sectioned view of the first embodiment of the control valve,

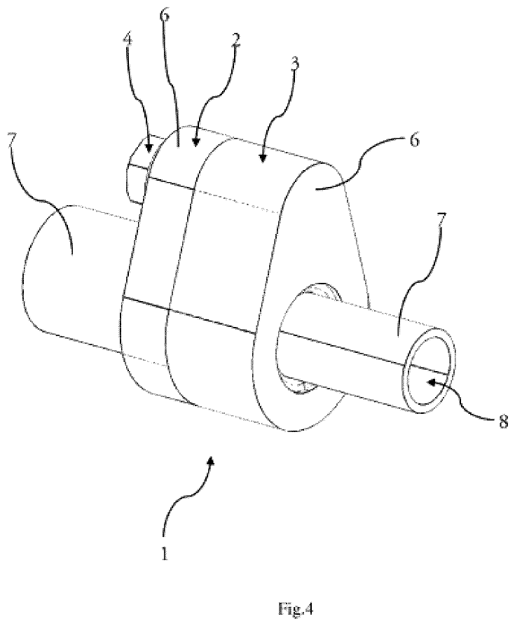

FIG. 4 shows a general view of a second embodiment of the control valve,

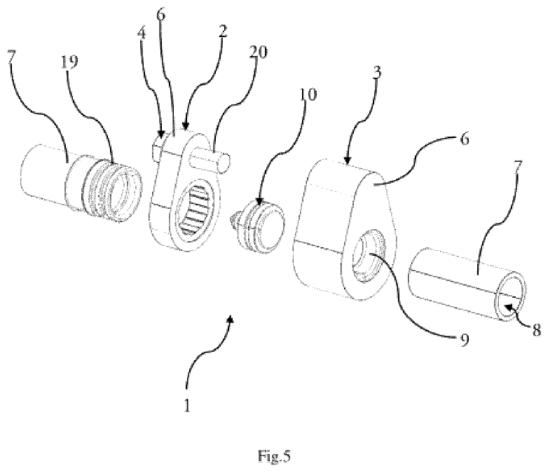

FIG. 5 shows an exploded view of the second embodiment of the control valve,

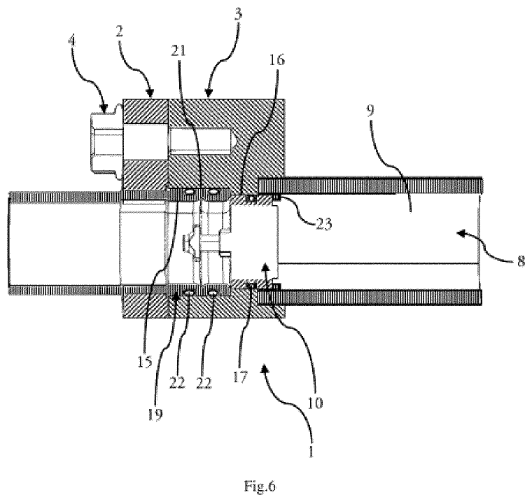

FIG. 6 shows a sectioned view of the second embodiment of the control valve,

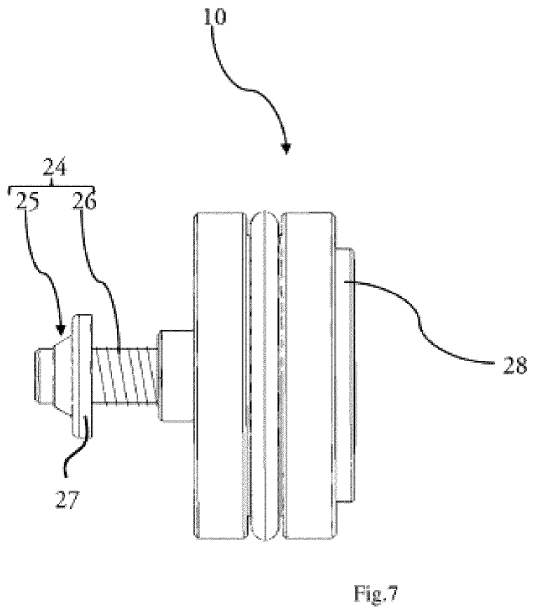

FIG. 7 illustrates a control device of the control valve configured in accordance with a first position,

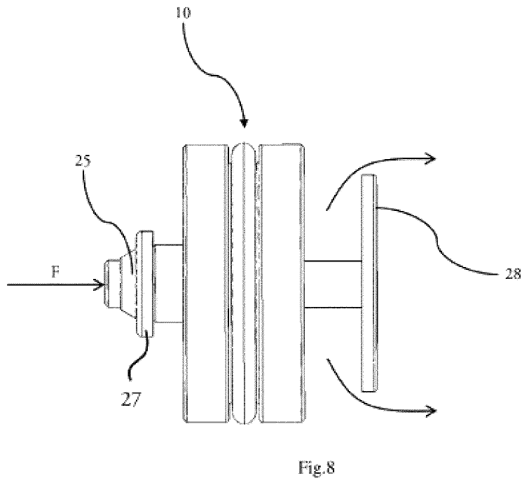

FIG. 8 illustrates the control device of the control valve configured in accordance with a second position.

FIG. 1 shows a general view of a control valve 1 according to the invention. The control valve 1 is, for example, suitable for integration within a heat treatment circuit of a motor vehicle.

The control valve 1 comprises a first connection element 2 and a second connection element 3 which are mechanically connected to each other via fixing means 4.

The first connection element 2 and the second connection element 3 each comprise a plate 6 and a conduit portion 7. The connection elements 2, 3 are in contact with each other via the respective plates 6 thereof which are pressed against each other. The fixing means 4 are positioned in the region of radial projections of the plates 6 of each of the connection elements 2, 3 and they are configured to mechanically ensure that the plates are retained against each other.

The conduit portions 7 of each of the connection elements 2, 3 extend in a manner opposite each other. Each of the conduit portions 7 can contribute to a mechanical and fluidic connection with another element of the heat treatment circuit within which the control valve 1 is integrated.

Once the first connection element 2 and the second connection element 3 are mechanically assembled with each other, a conduit 8 is formed. The conduit 8 is defined by the association of the two connection elements 2, 3 and is delimited by an internal volume 9 of each of them. The internal volume 9 of each connection element 2, 3 is more particularly defined by a recess which extends continuously between the plate 6 and the conduit portion 7 of each connection element 2, 3.

As will become evident below, the control valve 1 comprises a control device which is arranged within the conduit 8, that is to say within the internal volume 9 of the first connection element 2 and/or the internal volume 9 of the second connection element 3.

The control device ensures the control of the circulation of a fluid through the conduit 8. Such a fluid may be, for example, a refrigerating fluid which circulates in the heat treatment circuit and which is configured to operate a heat treatment of a passenger compartment of the vehicle by heat exchange.

As a result of the integration of the control device within the connection elements 2, 3, the compactness of the control valve 1 according to the invention is improved.

FIG. 2 illustrates a first embodiment of the control valve 1 as an exploded view. FIG. 2 thus allows illustration of the control device 10 set out above. FIG. 2 thus makes it possible to observe that the plates 6 of each connection element have an opening 11 which allows the fluid to potentially pass through the control valve 1 from one conduit portion 7 to another.

According to the first embodiment, the control device 10 comprises two fluidic connectors 12, each of these fluidic connectors 12 being capable of being inserted within one of the connection elements 2, 3. The control device 10 further has a shoulder 100 which is formed by a change in dimensions, in particular an external diameter, from one fluidic connector to the next. This shoulder 100 is particularly advantageous for positioning the control device 10 within the connection elements 2, 3.

The dimensions, particularly a diameter, of each fluidic connector 12 are such that the fluidic connector 12 can be inserted within the internal volume 9 of the connection element 2, 3 facing it. The dimensions of the fluidic connector 12 are particularly dependent on a diameter of the opening 11 and/or a diameter of the conduit portion 7 of the connection element 2, 3, within which the fluidic connector 12 is inserted.

Thus, the control device 10 according to the first embodiment of the control valve 1 is arranged partially within the internal volume 9 of the first control element 2 and partially within the internal volume 9 of the second connection element 3.

The first connection element 2 and the second connection element 3 are in direct contact with each other so that the plates 6 of these connection elements 2, 3 are pressed against each other and the fixing means 4 can be used.

By way of example and as illustrated in FIG. 2, the plate 6 of the first connection element 2 may comprise a screw 13 while the plate 6 of the second connection element 3 may comprise an opening 14. During assembly, the screw 13 extends through the opening 14. The fixing means 4 can thus be supplemented by a nut which is not illustrated in FIG. 2 and which is screwed onto the screw 13 and which presses the plates of the connection elements 2, 3 against each other.

FIG. 3 is a sectioned view of the first embodiment of the control valve 1 once assembled. As described above, the control device 10 is partially inserted within the internal volume 9 of each of the connection elements 2, 3.

More specifically, the internal volume 9 of each connection element 2, 3 is delimited by an internal wall 15. The control device 10 in turn comprises an external wall 16 which extends in the region of the fluidic connectors 12.

When the control valve 1 is assembled, the external wall 16 of the control device 10 is opposite or in contact with the internal wall 15 of each connection element 2, 3.

In order to ensure the sealing of the control valve 1, the control device 10 comprises a plurality of sealing members 17. The sealing members 17 may, for example, be joints made of flexible polymer material which extends circumferentially around the control device 10, along the external wall 16. To this end, the control device 10 may comprise grooves 18 which are formed in the external wall 16 and which are intended to receive the sealing members 17.

When the control valve 1 is assembled, the sealing members 17 are in contact with the internal wall 15 which delimits the internal volume 9 and they thus ensure the sealing between the control device 10 and the connection elements 2, 3. The fluid which circulates in the conduit 8 thus cannot be introduced between the control device and the internal wall 15 of the connection elements 2, 3 and it must necessarily pass through the control device 10 in order to circulate within the conduit 8.

In a preferred manner, the sealing members 17 are distributed so that the internal wall 15 of each of the connection elements 2, 3 is in contact with at least one of the sealing members 17. Advantageously, and as illustrated in FIG. 3, the sealing between the control device 10 and each internal wall 15 of each connection element 2, 3 is two-fold, that is to say carried out by two sealing members which are arranged axially one after the other in order to reinforce the efficacy of the sealing.

As set out above, the control device comprises a shoulder 100 which moves into abutment during assembly against one of the plates in order to form an axial positioning abutment.

FIG. 4 shows a general view of a second embodiment of the control valve 1 according to the invention. Again, the control valve comprises two connection elements 2, 3 which are fixed to each other at the plate 6 thereof by the fixing means 4. As in the first embodiment, the conduit 8 is also formed by the mechanical and fluidic connection of the connection elements 2, 3 and their internal volumes.

FIG. 5 shows an exploded view of the second embodiment of the control valve 1, the view making it possible to observe the distinction with respect to the first embodiment.

This is because the first connection element 2 of the second embodiment is provided with an end piece 19, the dimensions of which, in particular a diameter of the end piece 19, are provided so that the end piece 19 can be inserted within the internal volume 9 of the second connection element 3. Thus, unlike the first embodiment, one of the connection elements 2, 3 is at least partially arranged within the other connection element 2, 3 when they are pressed against each other.

As will be seen below, the control device 10 is also contained within the internal volume 9 of the second connection element 3. The control device 10 in this case does not have any fluidic connectors.

Here, the fixing means 4 is a bolt 20 which extends through the plate 6 of the first connection element 2. The bolt 20 can be inserted within a thread which is formed in the plate 6 of the second connection element 3, the thread not being visible in FIG. 5. However, the type of fixing means 4 is not specific to one or other of the embodiments of the control valve 1.

Reference may further be made to the description of FIG. 2 with regard to the structural and functional features common to the two embodiments.

FIG. 6 shows a view in cross section of the second embodiment of the control valve 1. As set out above, the end piece 19 of the first connection element 2 is inserted within the internal volume 9 of the second connection element 3, the internal volume 9 being delimited by the internal wall 15 of the second connection element 3. The dimensions, in particular the diameter, of the end piece 19 are provided so that it can be inserted within the second connection element 3.

The end piece 19 further comprises an external surface 21 which moves into contact or substantially into contact with the internal wall 15 of the second connection element 3. In order to ensure the sealing between the first connection element 2 and the second connection element 3, the end piece 19 comprises at least one sealing element 22 which extends along the external surface 21 of the end piece 19. As with the sealing member 17, the sealing element 22 can be inserted within a housing which is formed over the circumference of the end piece in the region of the external surface 21, and may be a joint which is made of flexible polymer material and which extends circumferentially around the end piece 19. The sealing element 22 thus prevents fluid from being introduced between the end piece 19 and the second connection element 3.

The fixing device 10, as for the first embodiment, comprises the sealing member 17 around the external wall 16 thereof, the external wall 16 being in contact or substantially in contact with the internal wall 15 of the second connection element 3. The sealing member 17 prevents fluid from being introduced between the contact device 10 and the internal wall 15 of the second connection element 3. Therefore, the fluid must necessarily pass through the control device 10 in order to circulate completely within the conduit 8.

The end piece 19 has a diameter which is equal or substantially equal to the diameter of the control device 10. Therefore, the control device 10 is engaged between the end piece 19 and the second connection element 3. To this end, the second connection element 3 may comprise an abutment 23 which ensures the correct positioning of the control device 10 relative to the second connection element 3.

FIGS. 7 and 8 illustrate an exemplary embodiment of the control device 10 in accordance with a first position and a second position, respectively. The control device 10 comprises a main body which is passed through by a piston/spring assembly 24 which is provided with a piston 25 and a spring 26 which is arranged around the piston. The piston 25 comprises a rod around which the spring 26 is mounted and a plate 27 against which the fluid can press in order to push the plate 27 of the piston counter to the spring 26. The control device 10 also comprises a valve 28 which is mechanically connected to the piston 25, that is to say here connected to the end of the rod of the piston opposite the plate 27 and the spring 26, and which is sized to cover where necessary an opening which passes through the body of the control device 10.

The control device 10 as illustrated in FIGS. 7 and 8 can be integrated in any embodiment of the control valve described above. The control device is such that it prevents the circulation of the fluid in a particular direction, that is to say when the fluid circulates from the valve 28 toward the piston 25. The valve 28 thus closes access to the passage of the control device 10, as illustrated in FIG. 7.

The spring 26 has a return mechanism which, when no external force is applied to the piston 25, is relaxed and retains the piston 25 in accordance with the first position illustrated in FIG. 7.

When an external force, for example, the force of the circulation of the fluid, is applied to the plate 27 of the piston 25 in one direction F, the piston 25 is then displaced into the second position, as illustrated in FIG. 8. The piston 25, under the effect of the force of the circulation of the fluid, then compresses the spring 26 and thus brings about lifting of the valve 28, thereby releasing a passage so that the fluid can pass through the control device 10 and thus flow within the conduit. The control device 10 as illustrated allows the circulation of fluid only if the circulation direction of the fluid is identical to the direction F of the force applied to the piston 25.

When the force in the direction F is no longer applied to the piston 25, the spring 26 relaxes and again displaces the piston 25 toward the first position illustrated in FIG. 7. The valve 28 thus moves so as to re-close the passage and blocks any fluid circulation through the control device 10.

The invention, as described above, effectively achieves the object proposed for it by providing a compact control valve which comprises two connection elements and a control device which is directly integrated within one of the connection elements or within the connection elements.

Of course, the invention is not limited to the examples which have just been described, and many modifications may be made to these examples without departing from the scope of the invention. Variants that are not described herein could be implemented without departing from the context of the invention, provided that, in accordance with the invention, they comprise a control valve according to the invention.

1. A control valve for a fluid circulation for a heat treatment circuit of a vehicle, comprising:
a first connection element;
a second connection element which mechanically interacts with the first connection element,
the first connection element and the second connection element both defining an internal volume; and
a conduit which is formed by the internal volume of the first connection element and by the internal volume of the second connection element and a control device which is at least partially integrated within the conduit.

2. The control valve as claimed in claim 1, wherein the control device is integrally arranged within the conduit.

3. The control valve as claimed in claim 1, wherein the control device comprises a piston/spring assembly which is configured to block one direction of circulation of the fluid which circulates in the conduit.

4. The control valve as claimed in claim 1, wherein the first connection element and the second connection element comprise fixing means, the fixing means ensuring positioning of the internal volumes of the first connection element and the second connection element opposite each other.

5. The control valve as claimed in claim 1, wherein the first connection element and the second connection element comprise an internal wall which at least partially defines the internal volume, the control device comprising an external wall which is arranged opposite at least one of the internal walls of the first connection element or the second connection element.

6. The control valve as claimed in claim 5, wherein the control device comprises at least one sealing member which extends along the external wall, the sealing member being in direct contact with the internal wall of at least the first connection element or the second connection element.

7. The control valve as claimed in claim 1, wherein the control device comprises two fluidic connectors, each of the fluidic connectors being capable of being inserted within each of the internal volumes of each of the connection elements by form-fitting connection.

8. The control valve as claimed in claim 5, wherein the first connection element comprises an end piece which is capable of being inserted within the internal volume of the second connection element by form-fitting connection.

9. The control valve as claimed in claim 8, wherein the end piece comprises an external surface which is arranged opposite the internal wall of the second connection element, the end piece comprising at least one sealing element which extends along the external surface, the sealing element being in direct contact with the internal wall of the second connection element.

10. The control valve as claimed in claim 8, wherein the control device is engaged between the second connection element and the end piece.

11. The control valve as claimed in claim 1, wherein the first connection element and/or the second connection element comprise(s) at least a conduit portion which is configured to mechanically and fluidically connect the control valve to the heat treatment circuit.
